(19) United States
(12) Patent Application Publication
(10) Pub. No.: US 2017/0332417 A1
(43) Pub. Date: Nov. 16, 2017

(54) Random Access Procedure and Burst Transmission in a High Frequency System

(71) Applicant: Futurewei Technologies, Inc., Plano, TX (US)

(72) Inventors: Nathan Edward Tenny, Poway, CA (US); Bin Liu, San Diego, CA (US); Richard Stirling-Gallacher, San Diego, CA (US); Jian Wang, Beijing (CN)

(21) Appl. No.: 15/156,180

(22) Filed: May 16, 2016

(51) Int. Cl. H04W 76/02; H04W 16/28; H04W 72/12; H04W 88/08; H04W 88/02

(52) U.S. Cl. CPC H04W 76/02; H04W 72/1289; H04W 72/1284; H04W 16/28; H04W 88/02; H04W 88/08

(57) ABSTRACT

An embodiment method for transmitting information between a user equipment (UE) and a transmission point (TP) is disclosed that includes transmitting, by the UE, a first message from the UE to the TP, the first message including a locally scoped user equipment ID (UE ID) and a request for random access. The UE receives a second message from the TP that includes a random access grant and the UE ID. The UE determines if the second message is directed to the UE by UE ID transmitted in the second message. The UE transmits a third message to the TP, the third message including a data burst.

### TECHNICAL FIELD

The present invention relates generally to a system and method for a random access procedure in a high frequency (e.g. millimeter wave (mmWave)) wireless system, and, in particular embodiments, to a system and method for such a procedure within a cellular communications system.

### BACKGROUND

Providing enough wireless data capacity to meet demand is an ongoing challenge. One area under consideration in next generation cellular communication standards (5G) for providing additional bandwidth is to use high frequency bands (e.g. greater than 6 GHz). However, high frequency carriers have limitations. For example, wireless signals that are communicated using carrier frequencies between 30 Gigahertz (GHz) and 300 GHz are commonly referred to as millimeter Wave (mmWave) signals because the wavelength of a 30 GHz is about 10 mm and the wavelength decreases with frequencies higher than 30 GHz. Therefore, wavelengths that are measured in single digits of millimeters begin at approximately 30 GHz. There are a variety of telecommunication standards that define protocols for communicating using high frequency bands such as mmWave signals. However, due to the attenuation characteristics of wireless signals exceeding 30 GHz, mmWave signals tend to exhibit high, oftentimes unacceptable, packet loss rates when transmitted over relatively long distances, and consequently have been used primarily for short-range communications (e.g., under 100 meters).

To combat this limitation, several techniques have been developed. In particular, multiple-input and multiple-output, or MIMO antenna arrays with sophisticated beamforming techniques have been successfully demonstrated. However, beamforming produces a highly concentrated beam to a specific spot. If the receiving user device is mobile, any movement by the user device can disrupt the connection. In addition, higher frequency connections are relatively fragile. They require a clear line of sight and can be easily disrupted by blockage. Thus, the link is disrupted often. Each disruption requires reacquiring the link, which creates a large amount of overhead just to keep the link active. Nonetheless, mmWave signals are attractive because of their high data carrying capacity. Therefore, there is a need for techniques to overcome the limitations of mmWave transmission in order to take advantage of its high capacity.

### SUMMARY

In accordance with an embodiment of the present invention, a method for transmitting information between a user equipment (UE) and a transmission point (TP) includes transmitting, by the UE, a first message from the UE to the TP, the first message including a locally scoped user equipment ID (UE ID) and a request for random access. The UE receives a second message from the TP that includes a random access grant and the UE ID. The UE determines if the second message is directed to the UE by UE ID transmitted in the second message. The UE transmits a third message to the TP, the third message including a data burst.

Another embodiment provides a method for establishing an connection between a user equipment (UE) and a transmission point (TP) including transmitting, by the UE, a first message from the UE to the TP, the first message including a locally scoped user equipment ID (UE ID) and a request for random access. The UE receives a second message from the TP. The second message includes a random access grant and the UE ID. The UE determines if the second message is directed to the UE by the UE ID transmitted in the second message. The UE receives a third message from the TP including connection setup information. The UE configures itself in accordance with the connection setup information. The UE establishes a connection between the UE and the TP for the transmission of data using a non-random access resource.

Another embodiment includes a method for transmitting information between a user equipment (UE) and a transmission point (TP) including receiving, by the TP, a first message from the UE to the TP, the first message including a locally scoped user equipment ID (UE ID) and a request for random access. The TP transmits a second message to the UE. The second message includes a random access grant and the UE ID to enable the UE to determine if the second message is directed to the UE by UE ID transmitted in the second message. The TP receives a third message from the UE, the third message including a data burst.

Another embodiment provides a method for establishing an connection between a user equipment (UE) and a transmission point (TP) including receiving, by the TP, a first message from the UE to the TP, the first message including a locally scoped user equipment ID (UE ID) and a request for random access. The TP transmits a second message to the UE. The second message includes a random access grant and the UE ID to enable the UE to determine if the second message is directed to the UE by UE ID transmitted in the second message. The TP transmits a third message to the UE that includes connection setup information to enable the UE to be configured in accordance with the connection setup information. The TP establishes a connection between the UE and the TP for the transmission of data using a non-random access resource.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of a wireless communications network;

FIG. 2 is a process diagram showing an embodiment process;

FIG. 3 is a process flow diagram of the process of FIG. 2;

FIG. 4 is a diagram of an embodiment process for establishing a persistent RRC connection;

FIG. 5 is process diagram for another embodiment process that creates an RRC connection;

FIG. 6 is a process diagram of another embodiment process;

FIG. 7 is a block diagram illustrating an embodiment processing system for performing methods described herein; and

FIG. 8 is a block diagram illustrating a transceiver adapted to transmit and receive signaling over a telecommunications network.

### DETAILED DESCRIPTION OF ILLUSTRATIVE EMBODIMENTS

The structure, manufacture and use of the preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Embodiments described herein include a system and method suitable for use in an higher frequency wireless communications system. The system includes a transmission point (TP) operating in a wireless network using the higher frequency spectrum. An example transmission device is an enhanced Node B (eNB). The method involves random access by a user device (user equipment or UE). The UE transmits over known random access radio resources a message requesting a grant of radio resources to be used for transmitting an uplink burst. The message includes a locally scoped UE identifier. The TP sends a message to the UE that includes the UE identifier and the uplink grant. Other UEs that may also be requesting an uplink grant can determine from the UE identifier that this grant is not for them and will not use this grant. The UE then transmits using the uplink resources indicated in the grant. Because of the high capacity of higher frequency channels, a significant volume of data transmission may be achieved before any degradation of the link, e.g., within one transmission time interval (TTI) or a small number of TTIs. In an embodiment, the uplink channel is configured in a time multiplexed configuration. That is, multiple UEs may use the uplink channel. However, only one UE may use it during a particular time period. Other UEs are granted access during other time periods, but only one at a time. In this configuration, the entire bandwidth of the channel is available, thus providing a greater channel capacity as compared to frequency multiplexing, which requires guard bands that diminish the data transmission bandwidth. In a time multiplexed configuration that is known to the UE, a timing relationship between uplink and downlink transmissions may facilitate a mapping between uplink and downlink resources. Such a mapping may in turn facilitate the identification of random access radio resources by a UE.

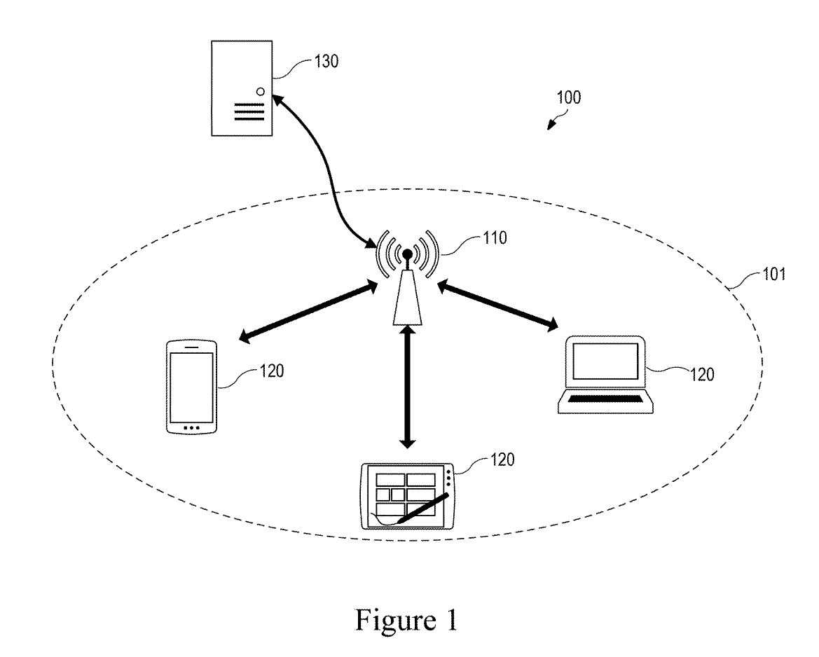

FIG. 1 is a diagram of a wireless communications network 100. The wireless communications network 100 comprises TP 110 having a coverage area 101, a plurality of UEs 120, which may be fixed or mobile, and a backhaul network 130. As shown, TP 110 establishes uplink and/or downlink connections with UEs 120, which serve to communicate between the UEs 120 and TP 110. Data carried over the uplink/downlink connections may include data communicated between the UEs 120, as well as data communicated to/from a remote-end (not shown) by way of the backhaul network 130. As used herein, the term “transmission point” refers to any component (or collection of components) configured to provide wireless access to a network, such as a Wi-Fi access point (AP), an evolved Node B (eNB), a macro-cell, a femtocell, or other wirelessly enabled devices. Transmission points may provide wireless access in accordance with one or more wireless communication protocols, e.g., Wi-Fi IEEE 802.11a/b/g/n/ac/ad/ax/ay, Long Term Evolution (LTE), LTE advanced (LTE-A), High Speed Packet Access (HSPA). As used herein, the term “UE” refers to any component (or collection of components) capable of establishing a wireless connection with a TP, such as a mobile device, and other wirelessly enabled devices. In some embodiments, the network 100 may comprise various other wireless devices, such as relays, low power nodes, etc.

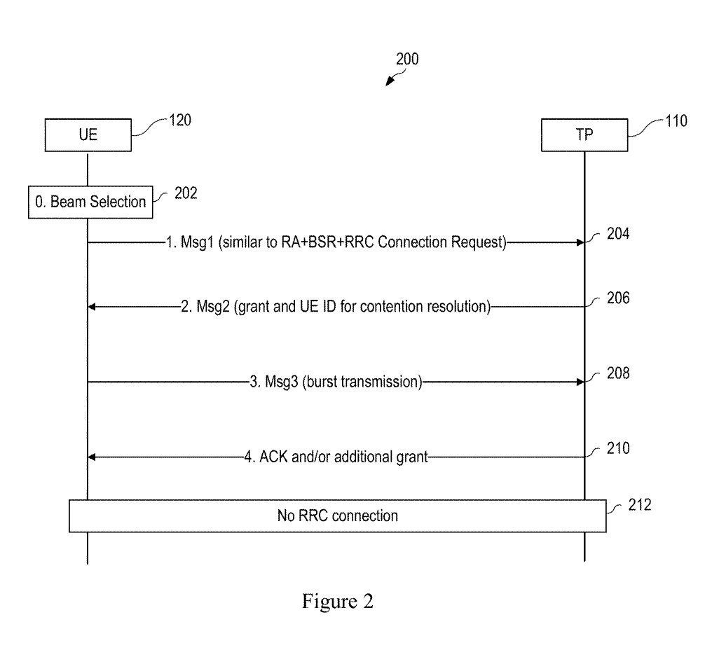

FIG. 2 is a process diagram showing process 200 which is an embodiment of this disclosure. Process 200 is a process for providing random access communications from UE 120 to TP 110.

The following conditions are assumed before process 200 begins:
a. TDD operation for each beam, in the sense that a downlink (DL) beam sent by the TP and received by a UE at a particular location at a certain time is complemented by an uplink (UL) beam usable by the UE transmitter and received by the TP at the same location at another time (which has a fixed offset time or time pattern with respect to the received beam), where the UL/DL time pattern (or time offset) for the beams operated by TP 110 is known to the UE 120.
b. The synchronization signals provided by TP 110 as part of its downlink configuration gives UE 120 enough information to apply the UL/DL pattern and find the next uplink transmit opportunity following a given time.
c. The random access resource configuration is known to UE 120 (e.g. from system information).
d. The UE 120 has a locally scoped UE ID. As used herein, a locally scoped UE ID is an ID that has a negligible probability of collision within the local area of the TP.
e. The UE 120 is in uplink synchronization with TP 110.
f. The random access resources of TP 110 provide enough bandwidth for a transmission comprising on the order of 100 layer 2 bits with a reasonable link budget, where layer 2 bits refers to bits of information conveyed between the layer 2 entities of a protocol stack similar to an OSI model stack. (Note that assumption f is intrinsically vague because the exact number of bits needed varies with many other unknowns such as the size of a UE ID, the selected modulation and coding parameters, the performance of radio components of UE 120 and TP 110 such as power amplifiers and antennae, etc.)

A random access connection is called random because it may be initiated at any time by the UE, e.g., in response to an input from the operator of the UE, a specified procedural triggering condition, a need to transmit data to the network, etc. This is in distinction with non-random communications between UE 120 and TP 110 where the TP determines the timing and conditions for communication, e.g., scheduled communications using radio resources specifically allocated by TP 110 for communication with UE 120. In step 202, the UE selects an uplink beam for communication to TP 110. With communication in higher frequency ranges, the severe attenuation of the signal with distance typically requires that beamforming be used to provide an appropriate link budget to support communication. Beamforming may be applied by UE 120, TP 110, or both, and a device performing beamforming may apply it to transmission, reception, or both. In some configurations, TP 110 will transmit several focused downlink beams serially in time within coverage area 101 (FIG. 1). When UE 120 enters the coverage area 101 of TP 110, TP 110 may transmit the information to UE 120 that is necessary to identify these downlink beams as well as corresponding uplink beams. Such information may comprise transmission and/or reception timing, ID code, etc. In an embodiment, UE 120 will continuously be measuring the quality of the downlink beams using, for example, measurements of signal strength, signal-to-noise ratio (SNR), and the like. When a random access transmission is needed by UE 120, UE 120 attempts to select the uplink beam with the best quality for its transmission in order to provide the best opportunity for clean communication with TP 110. Since the UE's measurements are performed on downlink beams while the attempted selection relates to an uplink beam, any inference made by UE 120 as to the quality of the selected beam is subject to potential error. For example, the relationship between the quality of a downlink beam and the quality of a related uplink beam may be distorted by link imbalance due to differential interference, differential antenna and/or propagation characteristics, and the like.

Using the selected beam, UE 120 sends Msg1 to TP 110 in step 204. As used under the LTE standard terminology, an Msg1 is an initial random access probe, unscheduled and using common radio resources. An Msg2 is the network response to the probe, containing a grant requested in Msg1. An Msg3 is the first message in the uplink using scheduled resources and supporting protocol features such as HARQ, layer 2 reliability, etc. While this specification uses this terminology for clarity, the use of these terms in this specification does not directly correspond to the use of these terms under LTE standard terminology. One or more of these message labels may pertain to a different message definition from that of the LTE standard terminology, as further explained below. In terms of messages and features used in LTE, Msg1 in process 200 is similar to a combination of random access (RA), buffer status report (BSR) and radio resource control (RRC) connection request. Msg1 is similar to a RA request because it is requesting access to an uplink using common resources with the possibility of contention. Msg1 is similar to a BSR in that it communicates the amount of data to be transmitted by the requested uplink. Msg1 is similar to an RRC connection request in that it includes necessary information for the TP to configure radio resource access for subsequent messaging and/or user data communications.

In addition, Msg1 includes a UE ID. This UE ID may be a packet-temporary mobile subscriber identity (P-TMSI), a cell ID with a cell radio network temporary identifier (C-RNTI) or other reasonably unique identifier. Permanent identifiers, such as international mobile subscriber identity (IMSI), are not optimal for this function for security reasons, but if a permanent identifier is used, it can facilitate the subsequent operations in the same way as the more preferred temporary identifiers.

In step 206, TP 110 transmits a UL grant along with the UE ID that it received in Msg1. The UE ID provides for contention resolution, ensuring that Msg2 will be recognized and accepted only by UE 120. Other UEs that may be contending for random access at the same time will also receive Msg2 containing the UL grant. However, because the message includes the UE ID for UE 120, those other UEs will know that the UL grant is not for them. Such other UEs may respond to this “loss of contention” outcome in various ways, such as declaring a failure of their own random access procedures to upper layers, waiting to send another Msg1 request, and so on.

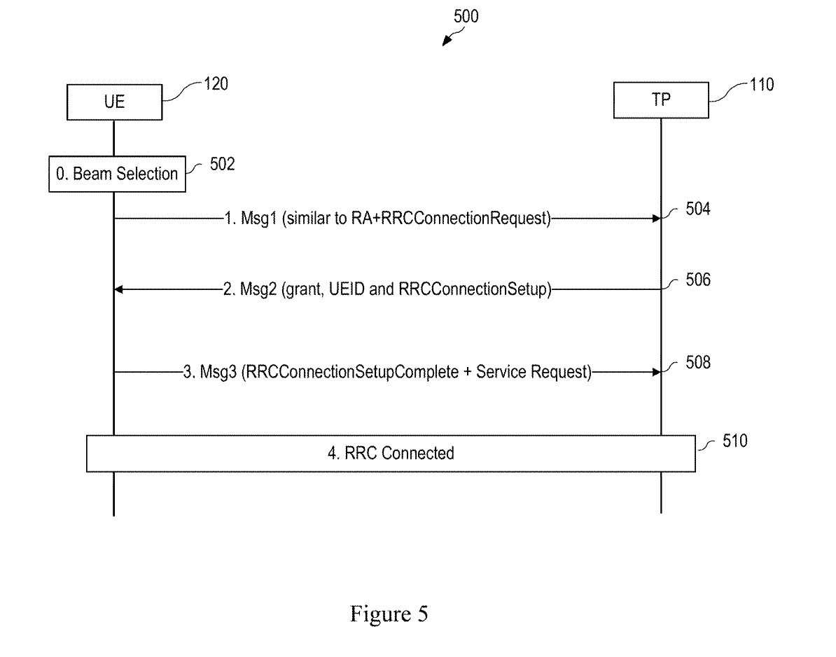

In step 208, UE 120 transmits UL data in a burst transmission mode as further recited below. In some cases, e.g., if a full Radio Resource Control (RRC) connection is requested, Msg3 208 is similar to the RRCConnectionSetupComplete message in LTE (see FIG. 5 below). In an embodiment, the message format of Msg3 may be used to distinguish between types of messages sent. In step 210, the TP 110 transmits an acknowledgement (ACK) and/or an additional grant if more capacity is needed to complete the transmission. In the case that the message in step 210 includes an additional grant, steps 3 and 4 may repeat, comprising an additional burst transmission followed by a corresponding additional ACK. This additional ACK could in turn include yet another additional grant, and so on until the data have been delivered successfully. After the last burst transmission in such a sequence has been acknowledged, assuming that Msg1 was not a full RRC connection request, the involved radio resources are released in step 212 because the transmission is complete. This releasing may take the form of dropping or releasing an RRC connection by TP 110 and/or UE 120, or of electing not to establish such a connection at all.

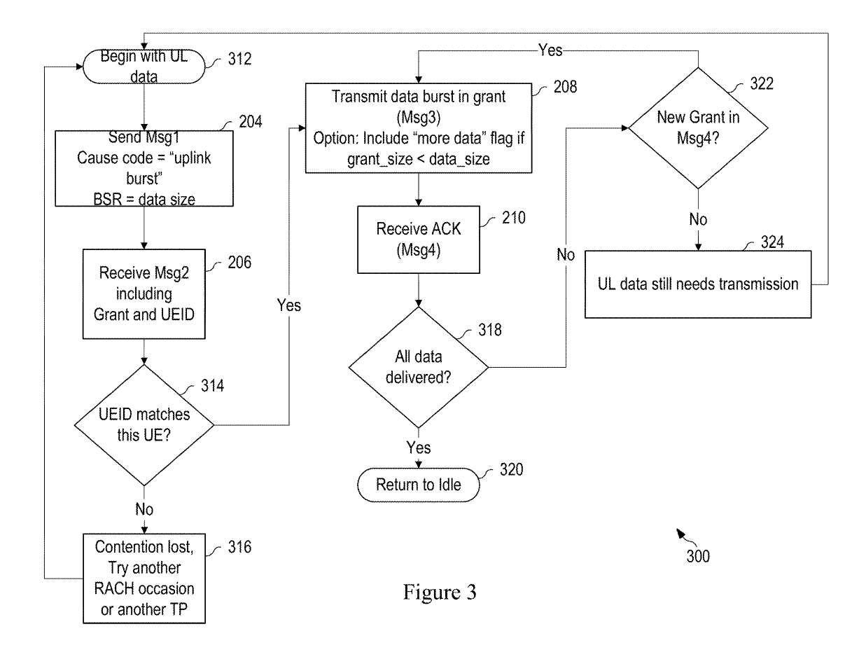

FIG. 3 is a process flow diagram of the process of FIG. 2. Process 300 is from the perspective of the UE 120 and begins at step 312. In step 204, an Msg1 is sent with a cause code of ‘uplink burst’ with a buffer status report (BSR) indicating the size of the burst, i.e., the amount of data for which transmission resources are requested. This BSR provides the information to the TP 110 to provide a grant of appropriate size. In step 206, Msg2 is received by UE 120 which includes the uplink grant and the UE ID. In step 314, it is determined if the UE ID in Msg2 matches the UE ID of UE 120. If not, it is determined in step 316 that contention is lost and the UE 120 must return to step 312 and retry access, e.g., at another time and/or using another TP. If the UE ID in Msg2 matches the UE ID of UE 120, step 208 is executed and the burst is transmitted to TP 110 using the radio resources indicated in the grant. If the size of the grant is less than the amount of data to be transmitted, this transfer may also include a ‘more data’ flag. In step 210, TP 110 sends an Msg4 ACK message acknowledging the data it received in step 208. In step 318, it is determined if all data have been sent. If so, the process completes, and UE 120 goes to idle mode in step 320. If not, it is determined if a new grant was included in Msg4 in step 322. If so, the process returns to step 208 to send the additional data using the new grant. If not, the process concludes in step 324 that the remaining uplink data require a new grant, and returns to the beginning step 312 to get an additional grant.

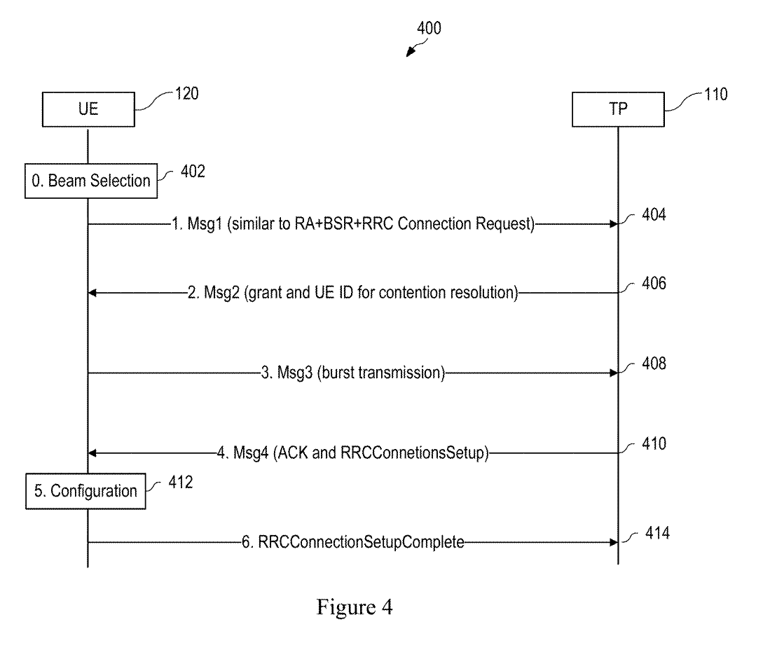

FIG. 4 is a diagram of a process 400 for establishing a persistent RRC connection subsequent to an uplink burst transmission. In step 402, UE 120 selects a beam from TP 110 for communication. In step 404, UE 120 transmits an Msg1 request message, similar to a combination of RA plus BSR plus RRC Connection Request. In step 406, TP 110 sends an Msg2 that includes an uplink grant and the UE ID to be used for contention resolution. In step 408, UE 120 sends an Msg3 that comprises a burst data transmission. In step 410, TP 110 sends an Msg4 that includes an ACK and configuration information for establishing an RRC connection, similar to an RRCConnectionSetup message in LTE. In step 412, UE 120 uses the configuration information provided in Msg4 to configure itself and complete the connection. In step 414, UE 120 sends an RRCConnectionSetupComplete message to indicate to TP 110 that it has configured the RRC connection.

FIG. 5 is a process diagram for another embodiment to create an RRC connection, based on a request initiated by UE 120. Such a request may indicate that UE 120 requires an RRC connection for sustained data transfer rather than for a single burst transmission, for example. In step 502, UE 120 selects a beam from TP 110. In step 504, UE 120 transmits Msg1, a message similar to a combination of RA plus RRCConnectionRequest. In step 506, TP 110 sends an Msg2 including an uplink grant, the UE ID (for contention resolution) and an RRCConnectionSetup. UE 120 uses the RRCConnectionSetup to configure itself and then, in step 508, sends an Msg3 including an RRConnectionSetupComplete message and an initial message for the service(s) required from the network, e.g., a service request. TP 110 and UE 120 now have an RRC connection as indicated in step 510. Thus, using this embodiment, two messages from UE 120 are used to create an RRC connection whereas four messages are necessary under LTE to create an RRC connection.

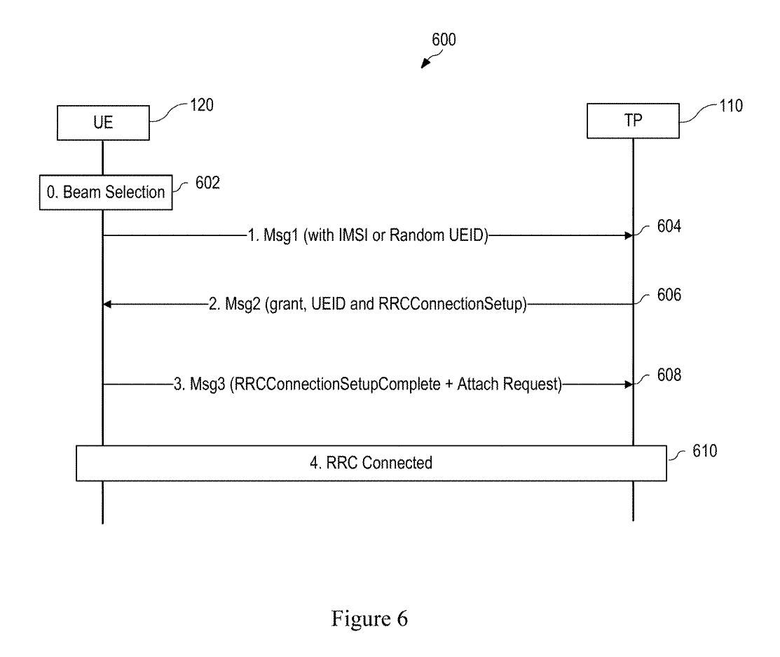

FIG. 6 is a process diagram of another embodiment. In process 600, UE 120 does not have an assigned temporary UE ID suitable for use in the random access procedure. In step 602, UE 120 selects a beam from TP 110. In step 604, UE sends an Msg1 that includes either a permanent UE identity, e.g., the international mobile subscriber identity (IMSI), or a randomly generated UE ID. For security reasons, using an IMSI is less desirable. The randomly generated UE ID can be, for example, 48 bits. With this number of bits, the probability of two UEs connected to the same TP generating the same UE ID is extremely low (on the order of 10⁻¹⁴). This provides a reasonably unique, locally scoped UE ID in that it is very unlikely that the ID will be duplicated. In addition, the UE ID is locally scoped in that it is used only for this procedure and may or may not be used in other procedures with other TPs. An additional option is to generate a secondary UE ID for this purpose. For example, a number such as a hash of the IMSI, a number stored on the SIM or otherwise provisioned may be used. In step 606, TP 110 sends an Msg2 including an uplink grant, the UE ID from Msg1, and an RRCConnectionSetup message. UE 120 uses the RRCConnectionSetup to configure itself and then, in step 608, sends an Msg3 including an RRConnectionSetupComplete message. It may also include an initial message of a protocol operation with the network, e.g., a non-access-stratum (NAS) protocol data unit (PDU). Such an initial message may comprise an attach request or similar message for establishing a context for UE 120 in the serving network, which may be needed for initial configuration inasmuch as UE 120 lacks the temporary UE ID (e.g., TMSI) that would ordinarily be provided during such an initial configuration. The UE 120 and TP 110 then have an RRC connection as shown in step 610. The RRC connection may be used, for example, to complete a procedure triggered by the initial message sent in Msg3.

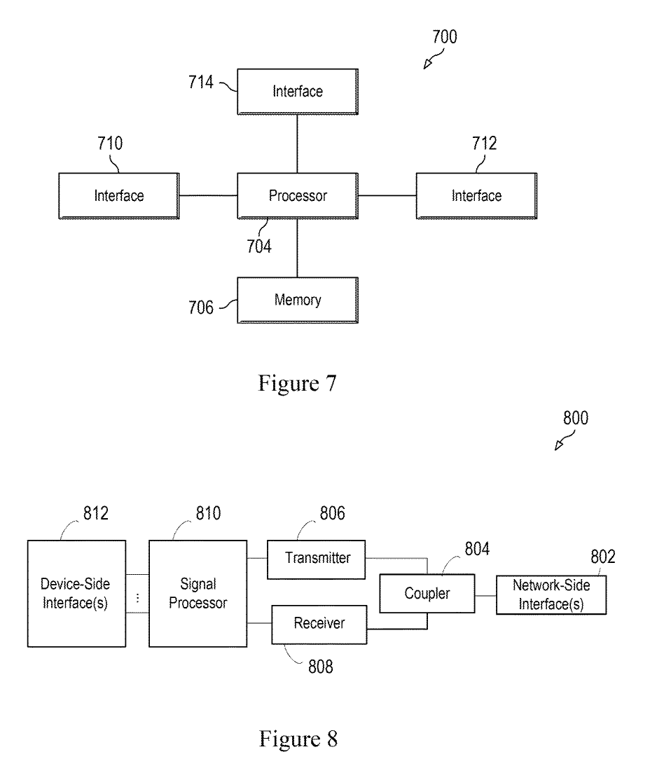

FIG. 7 illustrates a block diagram of an embodiment processing system 700 for performing methods described herein, which may be installed in a host device, such as a TP 110 or UE 120. As shown, the processing system 700 includes a processor 704, a memory 706, and interfaces 710-714, which may (or may not) be arranged as shown in FIG. 7. The processor 704 may be any component or collection of components adapted to perform computations and/or other processing related tasks, and the memory 706 may be any component or collection of components adapted to store programming and/or instructions for execution by the processor 704. In an embodiment, the memory 706 includes a non-transitory computer readable medium. The interfaces 710, 712, 714 may be any component or collection of components that allow the processing system 700 to communicate with other devices/components and/or a user. For example, one or more of the interfaces 710, 712, 714 may be adapted to communicate data, control, or management messages from the processor 704 to applications installed on the host device and/or a remote device. As another example, one or more of the interfaces 710, 712, 714 may be adapted to allow a UE to interact/communicate with the processing system 700. The processing system 700 may include additional components not depicted in FIG. 7, such as long term storage (e.g., non-volatile memory, etc.).

In some embodiments, the processing system 700 is included in a network device that is accessing, or part otherwise of, a telecommunications network. In one example, the processing system 700 is in a network-side device in a wireless or wireline telecommunications network, such as a base station, a relay station, a scheduler, a controller, a gateway, a router, an applications server, or any other device in the telecommunications network such as TP 110. In other embodiments, the processing system 700 is in a user-side device accessing a wireless or wireline telecommunications network, such as UE 120.

In some embodiments, one or more of the interfaces 710, 712, 714 connects the processing system 700 to a transceiver adapted to transmit and receive signaling over the telecommunications network. FIG. 8 illustrates a block diagram of a transceiver 800 adapted to transmit and receive signaling over a telecommunications network. The transceiver 800 may be installed in a host device, such as a TP 110 or UE 120. As shown, the transceiver 800 comprises a network-side interface 802, a coupler 804, a transmitter 806, a receiver 808, a signal processor 810, and a device-side interface 812. The network-side interface 802 may include any component or collection of components adapted to transmit or receive signaling over a wireless or wireline telecommunications network. The coupler 804 may include any component or collection of components adapted to facilitate bi-directional communication over the network-side interface 802. The transmitter 806 may include any component or collection of components (e.g., up-converter, power amplifier, etc.) adapted to convert a baseband signal into a modulated carrier signal suitable for transmission over the network-side interface 802. The receiver 808 may include any component or collection of components (e.g., down-converter, low noise amplifier, etc.) adapted to convert a carrier signal received over the network-side interface 802 into a baseband signal. The signal processor 810 may include any component or collection of components adapted to convert a baseband signal into a data signal suitable for communication over the device-side interface(s) 812, or vice-versa. The device-side interface(s) 812 may include any component or collection of components adapted to communicate data-signals between the signal processor 810 and components within the host device (e.g., the processing system 700, local area network (LAN) ports, etc.).

The transceiver 800 may transmit and receive signaling over any type of communications medium. In some embodiments, the transceiver 800 transmits and receives signaling over a wireless medium. For example, the transceiver 800 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 802 comprises one or more antenna/radiating elements. For example, the network-side interface 802 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 800 transmits and receives signaling over a wireline medium, e.g., twisted-pair cable, coaxial cable, optical fiber, etc. Specific processing systems and/or transceivers may utilize all of the components shown, or only a subset of the components and levels of integration may vary from device to device.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a transferring unit/module, an establishing unit/module, a transmission unit/module, a flow management unit/module, a location management unit/module, a routing unit/module, and/or a gateway unit/module. The respective units/modules may be hardware, software, or a combination thereof. For instance, one or more of the units/modules may be an integrated circuit, such as field programmable gate arrays (FPGAs) or application-specific integrated circuits (ASICs).

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for transmitting information between a user equipment (UE) and a transmission point (TP) comprising:
transmitting, by the UE, a first message from the UE to the TP, the first message including a locally scoped user equipment ID (UE ID) and a request for random access;
receiving, by the UE, a second message from the TP to the UE, the second message including a grant of radio resources and the UE ID, wherein the UE determines if the second message is directed to the UE based at least in part on the UE ID transmitted in the second message; and
transmitting a third message from the UE to the TP, the third message including a data burst.

2. The method of claim 1 further comprising receiving, by the UE, a fourth message from the TP to the UE acknowledging the third message.

3. The method of claim 1 wherein the UE and the TP uses beamforming and further including the step of the UE selecting a beam for transmission.

4. The method of claim 3 wherein the TP communicate using a millimeter wave carrier frequency.

5. The method of claim 1 wherein the UE ID is a random number generated by the UE.

6. The method of claim 1 wherein the UE ID is a hash of a number stored on the UE.

7. A method for establishing a connection between a user equipment (UE) and a transmission point (TP), the method comprising:
transmitting, by the UE, a first message from the UE to the TP, the first message including a locally scoped user equipment ID (UE ID) and a request for random access;
receiving, by the UE, a second message from the TP to the UE, the second message including a random access grant and the UE ID, wherein the UE determines if the second message is directed to the UE by the UE ID transmitted in the second message;
receiving, by the UE, a third message from the TP to the UE, the third message including a connection setup information;
configuring the UE in accordance with the connection setup information; and
establishing a connection between the UE and the TP for the transmission of data using a non-random access resource.

8. The method of claim 7 wherein the third message includes an acknowledgement.

9. The method of claim 7 wherein the UE ID is a random number generated by the UE.

10. The method of claim 7 wherein the UE ID is a hash of a number stored on the UE.

11. A method for transmitting information between a user equipment (UE) and a transmission point (TP) comprising:
receiving, by the TP, a first message from the UE to the TP, the first message including a locally scoped user equipment ID (UE ID) and a request for random access;
transmitting, by the TP, a second message from the TP to the UE, the second message including a random access grant and the UE ID to enable the UE to determine if the second message is directed to the UE by UE ID transmitted in the second message; and
receiving, by the TP, a third message from the UE to the TP, the third message including a data burst.

12. The method of claim 11 further comprising transmitting, by the TP, a fourth message from the TP to the UE acknowledging the third message.

13. The method of claim 11 wherein the UE and the TP communicate using a millimeter wave carrier frequency.

14. The method of claim 13 wherein the TP uses beamforming and further including the step of the UE selecting a beam for transmission.

15. The method of claim 11 wherein the UE ID is a random number generated by the UE.

16. The method of claim 11 wherein the UE ID is a hash of a number stored on the UE.

17. A method for establishing an connection between a user equipment (UE) and a transmission point (TP) comprising:
receiving, by the TP, a first message from the UE to the TP, the first message including a locally scoped user equipment ID (UE ID) and a request for random access;
transmitting, by the TP, a second message from the TP to the UE, the second message including a random access grant and the UE ID to enable the UE to determine if the second message is directed to the UE by UE ID transmitted in the second message;
transmitting, by the TP, a third message from the TP to the UE, the third message including a connection setup information to enable the UE to be configured in accordance with the connection setup information; and
establishing a connection between the UE and the TP for the transmission of data using a non-random access resource.

18. The method of claim 17 wherein the third message includes an acknowledgement.

19. The method of claim 17 wherein the UE ID is a random number generated by the UE.

20. The method of claim 17 wherein the UE ID is a hash of a number stored on the UE.
